(19) United States
(12) Patent Application Publication
(10) Pub. No.: US 2012/0207441 A1
(43) Pub. Date: Aug. 16, 2012

(54) APPARATUS, AND ASSOCIATED METHOD, FOR AUGMENTING SENSORY PERCEPTION OF SUBJECT OF INTEREST

(75) Inventors: James Allen Hymel, Kitchener (CA); Jean Phillipe Bouchard, Waterloo (CA); Jeffery Erhard Lindner, Los Gatos, CA (US)

(73) Assignee: RESEARCH IN MOTION LIMITED, Waterloo (CA)

(21) Appl. No.: 13/025,945

(22) Filed: Feb. 11, 2011

(51) Int. Cl. H04N 5/775

(52) U.S. Cl. 386/230; 386/E05.003

(57) ABSTRACT

An apparatus, and an associated method, for augmenting the viewing experience of a viewer of a subject of interest. The viewer carries a wireless, or other electronic, device that identifies the subject of interest and associates media content with the subject of interest. Once the media content is associated with the subject of interest, the media content is caused to be played out while the viewer views, or as otherwise in proximity to, the subject of interest.

The present disclosure relates generally to a manner by which to augment the sensory perception to a viewer of a subject of interest, such as a painting or statue. More particularly, the present invention relates to an apparatus, and an associated method, by which to associate audio, or other, media content with the subject of interest and to play out the media content when a viewer views the subject of interest.

When implemented at a wireless device having a media play-out feature and a camera feature, the wireless device is used to identify the subject of interest, to associate the media content with the subject of interest, and to play out the media content. The viewing experience of the user is augmented by causing the play-out of the media content while the viewer views the subject of interest. Media content is acted upon or selected based upon prior actions taken with similar content or as a result of a collaborative effort.

### BACKGROUND

Wireless devices are used by many both for business and for personal use. Wireless devices are typically of small dimensions, permitting such devices to be hand-carried or otherwise carried by a user to be available for use whenever needed to communicate.

Wireless devices are often times constructed to be operable in a cellular communication system. A cellular communication system includes network infrastructure that is installed over a geographical area. When a wireless device is positioned at a location within the area encompassed by the network infrastructure of the cellular communication system, a user of the wireless device is able to communicate by way of the network infrastructure to communicate there through. Controlled access is granted by an operator of the cellular communication system to ensure that only authorized devices are granted access to communicate by way of the network. Access is granted, e.g., pursuant to a subscription for service with the system operator, or an operator with which the system operator maintains an agreement to permit such communication. Various other wireless communication systems exhibit various of the aspects of cellular communication systems and include wireless devices that communicate with network infrastructure.

Early-generation communication systems, and the devices operable therein, provided voice communications services and limited data communication services. Successor-generation systems, and devices operable therein, provide for increasingly data-intensive communication services.

Such wireless devices often times provide multiple functionalities to permit a user of the wireless device to use the device for any of the multiple functionalities irrespective of whether the functionality immediately pertains to a communication service.

For instance, some wireless devices also include a camera element, i.e., a camera feature, that provides for the recordation of an image, or series of images forming a video sequence. The recorded image can be stored indefinitely at the wireless device. Or, a copy of an image is sometimes communicated to a remote location by way of the network infrastructure of the communication system. The camera element typically includes a lens assembly, control circuitry, and a view finder element, e.g., a LCD (Liquid Crystal Display) element that displays the subject towards which the camera lens is directed prior to recordation of the image. When so-implemented, the viewfinder is also typically further used to display the recorded images or video sequence.

Some wireless devices are also configured to provide media-player capabilities that permit play-out of media content, such as audio media content and multi-media content. The media content is, e.g., downloaded to the wireless device and made available to the media player feature of the wireless device. Additional functionalities are analogously sometimes also provided to the wireless device.

It is in light of this background information related to wireless devices that the significant improvements of the present disclosure have evolved.

### BRIEF DESCRIPTION OF THE DRAWINGS

FIG. 1 illustrates a functional block diagram of a communication system in which an implementation of the present disclosure is operable.

FIG. 2 illustrates a representation of exemplary positioning of the wireless device shown in FIG. 1 configured to operate pursuant to an implementation of the present disclosure.

FIG. 3 illustrates a process diagram representative of the process of operation of an implementation of the present disclosure.

FIG. 4 illustrates a method flow diagram representative of the method of operation of an implementation of the present disclosure.

### DETAILED DESCRIPTION

The present disclosure, accordingly, advantageously provides an apparatus, and an associated method, by which to augment the sensory perception to a viewer of a subject, such as a painting or a statue.

Through operation of an implementation of the present disclosure, a manner is provided by which to associate audio, or other, media content, with the subject of interest and to play out the media content when a viewer views the subject of interest.

In another aspect of the present disclosure, when implemented at a wireless device having a media play-out feature and a camera feature, the wireless device is used to identify the subject of interest, to associate the media content with the subject of interest, and to play out the associated media content. In another aspect of the present disclosure, media content is acted upon or selected based upon prior actions taken with respect to similar content or as a result of a collaborative effort.

In another aspect of the present disclosure, media content is recorded at the wireless device. The media content is modified automatically in response to prior medications made with respect to other, similar media content. Or, the content is modified automatically in a manner based upon a collaborative effort, such as modifications made upon similar content by members of a social media group.

In another aspect of the present disclosure, the subject of interest is first identified. The subject of interest is identified, for instance, by positioning a potential subject of interest within a view finder of a camera feature of the wireless device. The image of the potential subject of interest is compared with stored image information. If the potential subject of interest matches stored information, then the potential subject of interest is selected as the subject of interest, i.e., the selected subject of interest. Alternately, the subject of interest is selected responsive to signals received at the wireless device. The receive signals comprise, for instance, signals sent by the subject of interest, e.g., a sending device positioned in proximity to the subject that sends information related to the subject. And, the subject of interest is also selectable by a user of the wireless device.

In another aspect of the present disclosure, media content is associated with a subject of interest. The media content comprises, for instance, audio media content, that is made available for play-out at the wireless device as the user of the wireless device views the subject of interest.

In another aspect of the present disclosure, the media content associated with the subject of interest comprises user-selected media content, i.e., media content selected by the user to be associated with the subject of interest. The selection of the media content is, for instance selected at a prior time, and then, subsequently, the prior-selected media content is retrieved when the subject of interest is identified. Once retrieved, the media content is played-out while the user of the wireless device views the subject of interest.

In another aspect of the present disclosure, the media content is selected as a result of a collaborative effort. For instance, the media content is selected by a social media group to which the user of the wireless device belongs or is in some manner associated. For instance, other members of the social media group, or others of other groups howsoever defined, make selection of media content to be associated with the subject of interest, such as during prior dealings of the subject of interest. The prior selections of media content by others are stored, cumulated, or otherwise aggregated to form collaboratively-selected media content associated with the subject of interest.

In another aspect of the present disclosure, the media content, once associated with the subject of interest, is caused to be played out at the media player of the wireless device when the user of the wireless device used the subject of interest. The volume level, or other characteristic, of the media content is dependent upon the proximity of the user of the wireless device and, hence, the wireless device, to the subject of interest. The volume is, e.g., proportional to the proximity to the subject of interest. When the user is positioned in close proximity to the subject of interest, the volume at which the media content is played out is greater than when the user of the wireless device is positioned at a greater distance from the subject of interest. As the user move relative to the subject of interest, the characteristic of the play-out of the media content is correspondingly altered.

In one implementation, the user of the wireless device operates the camera feature of the device by positioning the device in an orientation to cause a subject to be viewed at the view finder of the wireless device. Music, or other media content, is associated with the subject. And, the associated media content is played out as the user of the wireless device remains in proximity of the subject. As the user moves closer, or farther away, from the subject, the volume of the music, or other media content, changes.

Successive subjects of interest are identified and content is associated with successive ones of the subject of interest. As the user of the wireless device moves from subject to subject, the associated media content of the different subjects is caused correspondingly to be successively played out. In one implementation, the user of the wireless device is permitted to override the associated media content and to select alternate media content, such as media content corresponding to the mood of the user, to be played out. The selected content is added, e.g., to a cloud database associated with the subject. And, the selected content is entered as a collaborative indicia of the content associated with the subject or is considered to be the content that is to be associated with the subject when the subject is subsequently again viewed.

In another implementation, the user of the wireless device selects a mood, and then uses the view finder of the wireless device to search for subjects that match the mood. The objects, e.g., that match the mood are highlighted, outlined, or otherwise identified in the viewfinder. The media player of the wireless device causes play-out of the mood-associated media content when the user is in proximity to the subject.

In these and other aspects, therefore, an apparatus, and an associated method, is provided for facilitating augmentation of sensory perception of a subject of interest. A subject identifier is configured to identify the subject of interest. An associator is configured to associate selected media content with the subject of interest. And, a media player is configured to play the selected media content associated by the associator.

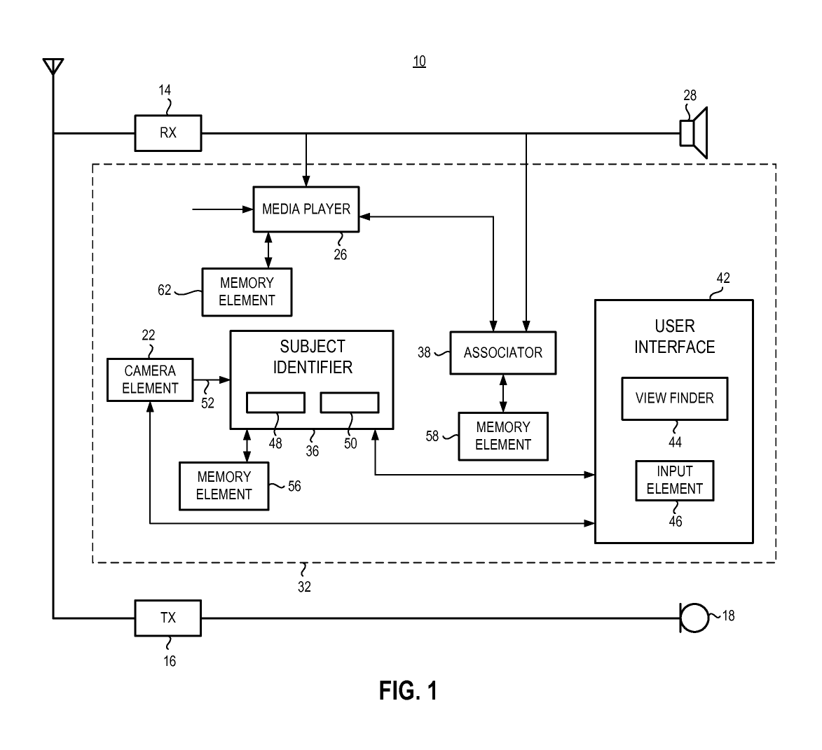

Referring first, to FIG. 1, a wireless device, shown generally at 10, includes transceiver circuitry, here represented by a receive part 14 and a transmit part 16, that operate to receive and to transmit, respectively, information signals during communication operations. A microphone 18, or other transducer, is coupled to the transmit part. In the exemplary implementation, the wireless device comprises a cellular mobile station, i.e., a wireless device that is operable in general conformity with the operating protocols of a cellular communication system. While the following description shall describe exemplary operation of the wireless device with respect to an implementation in which the wireless device comprises a cellular mobile station, in other implementations, the wireless device is configured to be operable with other types of communication systems.

The wireless device is, in the exemplary implementation, of dimensions permitting hand carriage by a user of the device. The wireless device is a multi-functional device, capable of performing multiple functions. Here, the wireless device also includes camera functionality provided by a camera element 22 and media play-out functionality provided by a media player 26. The camera element 22 provides for the capture of an image or sequence of images and includes, in conventional manner, a camera lens assembly, camera control circuitry, and other circuitry of conventional camera functionality. And, the media player element 26 comprises media player circuitry that plays out media content, such as audio content and multimedia content. Media content provided to, or accessed by, the media player is played out at a transducer, here an audio transducer 28 that transduces audio content into aural form.

In other implementations, the wireless device includes additional functionalities in addition to the media-player and camera functionalities.

Due to the portability of the wireless device, a user of the device is able easily to hand-carry the device or otherwise maintain the wireless device in a manner to permit ready availability of the device. The multiple functionalities of the device permit the user of the wireless device to utilize any of the provided functionalities.

The wireless device 10 operates pursuant to an implementation of the present disclosure by which to augment the sensory perception of the user when viewing selected subjects, such as painting some statutes of a museum, or the like. The augmentation comprises a form of augmented reality in which the selected media content is caused to be played out as the user of the wireless device views selected subjects of interest. The augmentation is carried out through use of an apparatus 32 of an implementation of the present disclosure. The apparatus 32 is functionally represented, formed of functional elements, implementable in any desired manner, including hardware implementations, firmware implementations, software algorithm executable by processing circuitry, and combinations thereof. The apparatus 32 is also used to modify images or sequences of images, once recorded.

In the exemplary implementation, the apparatus 32 is shown to include the just-mentioned camera element 22 and media player 26, the apparatus further includes a subject identifier 36, an associator 38, and a user interface 42. The user interface includes a display element, here forming a viewfinder 44, and an input element 46. And the subject identifier also includes a recorded-image subject identifier 48 and a modifier 50. In operation, the apparatus causes selected media content to be played out by the media player when the user of the wireless device is viewing a subject of interest. The acoustic transducer 28 forms, for example, a headset or earphone assembly that provides the media content in aural form to the user of the wireless device.

The subject identifier 36 is configured to identify a subject of interest. In one exemplary implementation, the subject of interest is identified through use of the camera element 22. The user of the wireless device positions the wireless device such that the camera lens of the camera element is directed towards a potential subject of interest. The image focused by the camera lens is displayed at the viewfinder 44 of the user interface. The display of the image is viewable by the user of the wireless device. Additionally, indications of the image are provided to the subject identifier, here indicated by way of the line 52. The subject identifier identifies the subject, if any, focused by the camera lens of the camera element. The subject identifier, in one implementation, identifies a potential subject of interest by comparing the indication of the sensed image with stored information, here stored at a memory element 56. That is, during operation, the subject identifier functions as a comparator to compare sensed information sensed by way of the camera element with stored information stored at the memory element 56.

If the sensed information matches stored information, the potential subject of interest is selectable as the selected subject of interest. The subject of interest is any object, animate or inanimate, that is amendable for viewing by a viewer. Selection is, in one implementation, inherently made by the positioning by the user of the wireless device to detect the sensed subject.

In another implementation, the subject of interest is identified in another manner, such as by way of manual selection entered by a user by way of the input element 46 or by detection at the receive part 14 of externally-generated signals that identify a subject within proximity to the wireless device. For instance, in one implementation, a Bluetooth™ transmitter positioned proximate to a subject of interest sends signals that are detected by the receive part 14, and indications are provided to the subject identifier. And, in response, the subject identifier identifies the subject of interest based upon the detected signals. Bluetooth™ is a proprietary open wireless technology standard for exchanging data over short distances (using short wavelength radio transmissions) from fixed and mobile devices. In other implementations other types of technology are used.

Once the subject of interest has been identified, an indication is provided to the associator 38. The associator functions to associate media content with the subject of interest. In one exemplary implementation, the associations made by the associator through access to a memory element 56. The memory element stores indications of media content associated with different subjects of interest. When the subject of interest is identified by the identifier 36 and provided to the associator, access to the memory element obtains the stored association. In another implementation, the associator associates the subject of interest identified by the subject identifier with social-media-derived, or other collaboratively-derived media content. For instance, an aggregation or accumulation is made of media content selected by others in a social-media group, or other defined group. The accumulated information is available to the wireless device, either by transmission thereto and reception by the receive part 14 or through prior storage at the memory element 56.

Once the association is made by the associator, an indication of the identified media content, associated with the subject of interest, is provided to the media player, and the media player is caused to retrieve the media content from the media storage element 62 and to play out the media content.

In one implementation, the volume level, or other characteristic, of the media content, when played out, is dependent upon the proximity of the wireless device to the subject of interest. In one implementation, when the wireless device, and the user that carries the wireless device, is positioned close to the subject of interest, the volume level is louder than when the wireless device is positioned farther away from the subject of interest. As a user approaches the subject of interest, the volume level increases or the other characteristic correspondingly changes. And, when the user walks away from the subject of interest, the volume level decreases, or the other characteristic correspondingly changes.

In another implementation, the subject identifier compares the sensed characteristics of the potential subject of interest and compares the indications with stored information. The stored information includes information related to prior subjects of interest viewed by the user of the wireless device. The subject identifier operates to identify a prior subject of interest that corresponds to, or is otherwise similar to, the potential subject of interest. Once a match is made of a prior subject of interest that is similar to the potential subject of interest, an indication is provided to the associator, and the associator associates media content with the potential subject of interest, forming the subject of interest, by way of the similar, prior subject of interest. Once the association is made, the media player is correspondingly caused to access the media content, and cause the media content, here stored at the memory element 62, to be played out.

In another implementation, the user of the wireless device selects a mood, such as a mood indicative of the current feelings of the user when viewing a subject. And, responsive to the entry of the mood information, e.g., via the input element 46, the subject identifier is caused to search, such as by access of the memory element 56, to identify other subjects, particularly those in proximity to the wireless device, that are associated with the same or similar mood as that entered by the user. Or, the camera element is used, in conjunction with the viewfinder 44, in a visual search of objects that correspond, or are similar to, the user-selected mood. The subject, once displayed at the viewfinder, if the displayed subject corresponds to a subject identified by the subject identifier, the viewfinder indicates the match in some manner, such as by highlighting the subject or outlining the image of the subject. Media content appropriate to the selected mood is caused to be played out by the media player.

In another implementation, the user inputs selection of a mood-type by way of the input element 46. The selection is entered as the user is viewing subjects of interest. The entered information is used by the apparatus 32 to cause appropriate media content to be played out as the user views the subject of interest. Additionally, the entered information, and associated subject of interest, is caused to be sent by the transmitter part 16 to a remote database (not shown) that cumulates or aggregates the provided information.

In another implementation, images are manipulated in a collaborative network. Pictures on the network are modified based upon past user actions. For instance, if a user always adjusts the white balance of images, future images would automatically have white-balanced adjustments. Images are also edited by multiple users of a user group, such as a user-defined group. Audio is also, if desired, added to the image to enhance the image and be associated with a particular geo location of the image. The audio is discovered, such as by an augmented reality technique, described above, by an authorized user who takes a picture at the location.

For instance, the images are modified or corrected based on the modifications provided by the user in past, either at the desktop of the user or in cloud configuration. The images are edited in real-time or at a subsequent time. For instance, the camera element 22 records an image. The recorded image is identified by the recorded-image subject identifier 48 of the subject identifier 36. And, the modifier 50 of the identifier 36 is configured to modify the recorded image. The modifier modifies the image based upon prior modifications of similar images or based upon collaboratively-determined modifications, such as modifications made upon similar images by members of a social-media, or other, group. The modification information is, e.g., stored at the memory element 56 and retrieved to determine in what manner to modify the captured image.

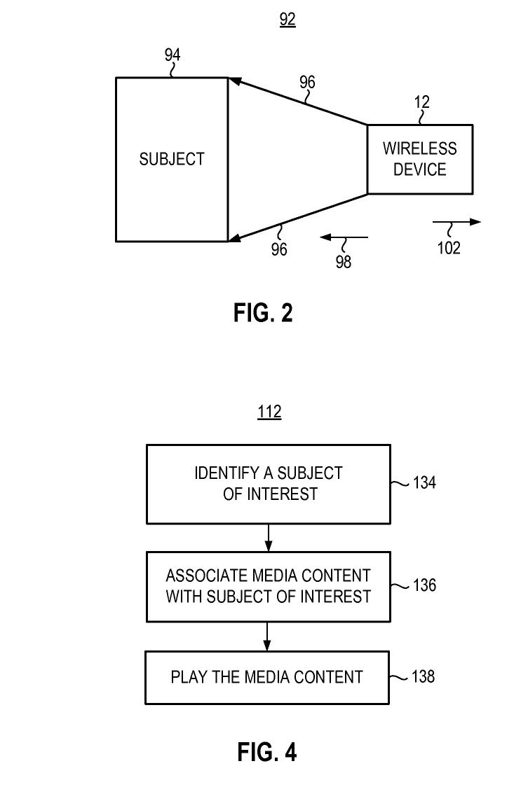

FIG. 2 illustrates a representation, shown generally at 92, representative of positioning of the wireless device 12 proximate to a subject of interest 94. The lines 96 are representative of the focusing of the subject 94 by a camera lens of a camera element (shown in FIG. 1) of the wireless device. As described above, the subject 94 is identified as a subject of interest, media content is associated with the subject of interest, and a media player is caused to play out the associated media content.

Arrows 98 and 102 shown in the figure are representative of changes in the volume, or other characteristic of the media content that is played out as the user of the wireless device moves, together with the wireless device. As the wireless devices is moved in the direction indicated by the arrow 98, the volume, or other characteristic, of the media content is increased. And, when the wireless devices moved in the direction indicated by the arrow 102, the volume is decreased, or the characteristic is otherwise correspondingly changed.

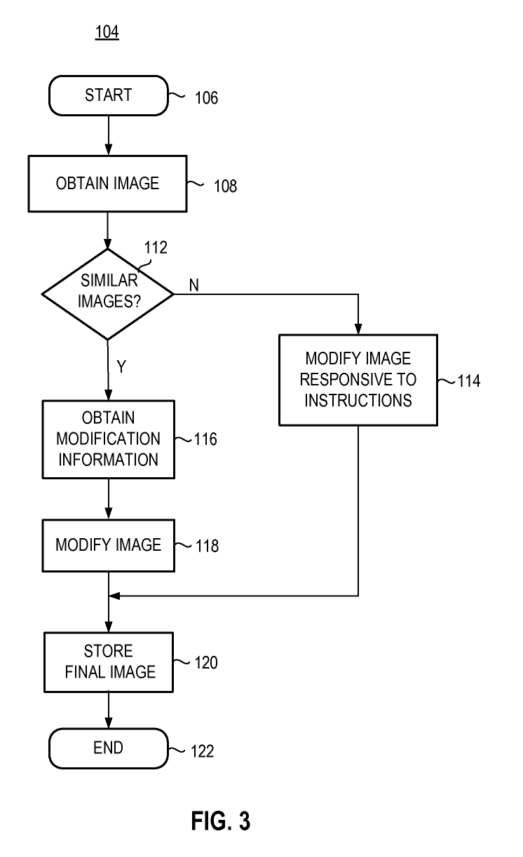

FIG. 3 illustrates a process 104 representative of exemplary operation of an implementation of the present disclosure. The process provides for modification of an image, such as a photographic image recorded by a camera element or a series of camera images forming a video sequence.

After start, indicated by the start block 106, an image is obtained, indicated by the block 108. The image is obtained, e.g., by a camera element of a wireless device.

Then, and as indicated by the decision block 112, a determination is made as to whether similar images have been previously modified. The determination is based upon either similar images modified by the same party that records the image or based upon modifications or decisions made by members of a collaborative group, such as a social-media group. If not, the no branch is taken, and the image is modified responsive to specific instruction, such as manual instruction by a user of the device at which the image is recorded, or elsewhere.

If, conversely, the determination is affirmative, the yes branch is taken to the block 116, and information related to the modifications made to the similar images is obtained. Then, and as indicated by the block 118, the image is modified in similar manner The modification is, in one implementation, carried out automatically.

Pads extending from the blocks 114 and 118 extend to block 120, and the final image is stored. The final image is modified, if modified at the block 118 or at the block 114. Then, the process ends, indicated by the end block 122.

FIG. 4 illustrates a method flow diagram 132 representative of the method of operation of an implementation of the present disclosure. The method facilitates augmentation of sensory perception of a subject of interest.

First, and as indicated by the block 134, the subject of interest is identified. Then, and as indicated by the block 138, selected media content is associated with the subject of interest. And, as indicated by the block 142, the selected media content is played out.

Thereby, the viewing experience of a user of the wireless, or other electronic, device that views a subject of interest is increased due to the augmentation of the media content selected to be appropriate for the subject of interest.

Presently preferred implementations of the disclosure and many of its improvements and advantages have been described with a degree of particularity. The description is of preferred examples of implementing the disclosure, and the description of examples is not necessarily intended to limit the scope of the disclosure. The scope of the disclosure is defined by the following claims.

What is claimed is:

1. An apparatus for facilitating augmentation of sensory perception of a subject of interest, said apparatus comprising:
a subject identifier configured to identify the subject of interest;
an associator configured to associate selected media content with the subject of interest identified by said subject identifier; and
a media player configured to play the selected media content associated by said associator.

2. The apparatus of claim 1 wherein said subject identifier comprises an image sense configured to sense a visual representation of the subject of interest and to identify the subject of interest responsive to the visual representation thereof.

3. The apparatus of claim 2 further comprising a subject database and wherein said subject identifier is configured to identify the subject of interest by comparing a sensed, visual representation with entries of the subject database and identification of the subject of interest responsive to a match of the sensed, visual representation with an entry of the subject database.

4. The apparatus of claim 1 wherein said subject identifier is configured to identify the subject of interest responsive to subject-of-interest-provided indicia.

5. The apparatus of claim 1 wherein said associator is configured to associate the subject of interest with viewer-selected media content.

6. The apparatus of claim 5 wherein the viewer-selected media content comprises viewer-selected-mood media content.

7. The apparatus of claim 6 wherein said associator is configured to associate the viewer-selected-mood media content with a viewer-selected subject of interest.

8. The apparatus of claim 1 wherein said associator is configured to associate the subject of interest with social-media-selected media content.

9. The apparatus of claim 1 wherein said media player is configured to play the selected media content at a level associated with proximity to the subject of interest.

10. The apparatus of claim 9 wherein said media player is configured to play the selected media content at a volume that is proportional to the proximity to the subject of interest.

11. The apparatus of claim 10 wherein said media player is configured to play the selected media content at a volume that is proportional to the proximity to the subject of interest.

12. The apparatus of claim 1 wherein said subject identifier is further configured to obtain proximity information associated with proximity to the subject of interest.

13. A method for facilitating augmentation of sensory perception of a subject of interest, said method comprising:
identifying the subject of interest;
associating selected media content with the subject of interest identified during said identifying; and
playing the selected media content associated during said associating.

14. The method of claim 13 wherein said identifying comprises comparing a sensed visual representation with entries of a subject database and detecting a match of the sensed visual representation with an entry of the subject database.

15. The method of claim 13 wherein said identifying comprises detecting subject-of-interest-provided indicia.

16. The method of claim 13 wherein said associating comprises associating the subject of interest with viewer-selected media content.

17. The method of claim 13 wherein said associating comprises associating the subject of interest with viewer-selected media content.

18. The method of claim 17 wherein said associating comprises associating the viewer-selected-mood media content with a viewer-selected subject of interest.

19. The method of claim 13 wherein said associating comprises associating the subject of interest with social-media-selected media content.

20. A method for facilitating augmentation by a wireless device of sensory perception of a selected subject of interest, said method comprising:
positioning a representation of a potential subject of interest in a viewfinder of a camera feature of the wireless device;
determining whether the potential subject of interest comprises the selected subject of interest; and
playing media content with the selected subject of interest at a media player feature of the wireless device if the potential subject of interest is determined during said determining to be the selected subject of interest.

21. An apparatus for facilitating modification of a recorded image, said apparatus comprising:
a recorded-image subject identifier configured to identify subject matter of the recorded image; and
a modifier configured selectably to modify the recorded image based upon prior modification of similar subject matter, similar to the subject matter of the recorded image.
